(19) United States
(12) Patent Application Publication
(10) Pub. No.: US 2006/0142560 A1
(43) Pub. Date: Jun. 29, 2006

(54) Sulfoalkylated cellulose

(76) Inventors: Wolfgang G. Glasser, Blacksburg, VA (US); Alena Michalek, Auburn, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/027,737

(22) Filed: Dec. 29, 2004

(51) Int. Cl. C08B 11/00

(52) U.S. Cl. 536/92

(57) ABSTRACT

Sulfoalkylated cellulose having superabsorbent properties and methods for making sulfoalkylated cellulose.

### FIELD OF THE INVENTION

The present invention relates to sulfoalkylated cellulose having superabsorbent properties and methods for making sulfoalkylated cellulose.

### BACKGROUND OF THE INVENTION

Personal care absorbent products, such as infant diapers, adult incontinent pads, and feminine care products, typically contain an absorbent core that includes superabsorbent polymer particles distributed within a fibrous matrix. Superabsorbents are water-swellable, generally water-insoluble absorbent materials having a high absorbent capacity for body fluids. Superabsorbent polymers (SAPs) in common use are mostly derived from acrylic acid, which is itself derived from oil, a non-renewable raw material. Acrylic acid polymers and SAPs are generally recognized as not being biodegradable. Despite their wide use, some segments of the absorbent products market are concerned about the use of non-renewable oil derived materials and their non-biodegradable nature. Acrylic acid based polymers also comprise a meaningful portion of the cost structure of diapers and incontinent pads. Users of SAP are interested in lower cost SAPs. The high cost derives in part from the cost structure for the manufacture of acrylic acid which, in turn, depends upon the fluctuating price of oil. Also, when diapers are discarded after use they normally contain considerably less than their maximum or theoretical content of body fluids. In other words, in terms of their fluid holding capacity, they are “over-designed”. This “over-design” constitutes an inefficiency in the use of SAP. The inefficiency results in part from the fact that SAPs are designed to have high gel strength (as demonstrated by high absorbency under load or AUL). The high gel strength (upon swelling) of currently used SAP particles helps them to retain a lot of void space between particles, which is helpful for rapid fluid uptake. However, this high “void volume” simultaneously results in there being a lot of interstitial (between particle) liquid in the product in the saturated state. When there is a lot of interstitial liquid the “rewet” value or “wet feeling” of an absorbent product is compromised.

In personal care absorbent products, U.S. southern pine fluff pulp is commonly used in conjunction with the SAP. This fluff is recognized worldwide as the preferred fiber for absorbent products. The preference is based on the fluff pulp's advantageous high fiber length (about 2.8 mm) and its relative ease of processing from a wetlaid pulp sheet to an airlaid web. Fluff pulp is also made from renewable and biodegradable cellulose pulp fibers. Compared to SAP, these fibers are inexpensive on a per mass basis, but tend to be more expensive on a per unit of liquid held basis. These fluff pulp fibers mostly absorb within the interstices between fibers. For this reason, a fibrous matrix readily releases acquired liquid on application of pressure. The tendency to release acquired liquid can result in significant skin wetness during use of an absorbent product that includes a core formed exclusively from cellulosic fibers. Such products also tend to leak acquired liquid because liquid is not effectively retained in such a fibrous absorbent core.

A need therefore exists for a superabsorbent material that is made from a biodegradable renewable resource like cellulose and that is inexpensive. In this way, the superabsorbent material can be used in absorbent product designs that are efficient such that they can be used closer to their theoretical capacity without feeling wet to the wearer. The present invention seeks to fulfill this need and provides further related advantages.

### SUMMARY OF THE INVENTION

In one aspect, the present invention provides sulfoalkylated cellulose having superabsorbent properties. The sulfoalkylated cellulose of the invention is water swellable, water insoluble, and has a high liquid absorption capacity. The sulfoalkylated cellulose of the invention is substituted with ethyl sulfonate groups and 2-hydroxypropyl sulfonate groups that are covalently coupled to cellulose through ether groups.

In another aspect of the invention, methods for making sulfoalkylated cellulose are provided. In the method, cellulose is treated with alkali to provide alkali cellulose. The alkali cellulose is sequentially treated with first and second sulfoalkylating agents to provide a sulfoalkylated cellulose that is isolated and dried. In one embodiment, the first sulfoalkylating agent is a haloethyl sulfonate, such as chloroethyl sulfonate. In one embodiment, the first sulfoalkylating agent is vinyl sulfonate. In one embodiment, the second sulfoalkylating agent is 3-chloro-2-hydroxypropyl sulfonate.

In other aspects, absorbent products that include sulfoalkylated cellulose are provided.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a cross sectional view of an absorbent construct incorporating sulfoalkylated cellulose of the invention and having an acquisition layer;

FIG. 2 is a cross sectional view of an absorbent construct incorporating sulfoalkylated cellulose of the invention and having acquisition and distribution layers; and

FIGS. 3A-C are cross sectional views of absorbent articles incorporating a composite including sulfoalkylated cellulose of the invention and the absorbent constructs illustrated in FIGS. 1 and 2, respectively.

### DETAILED DESCRIPTION OF THE PREFERRED EMBODIMENT

In one aspect, the present invention provides sulfoalkylated cellulose. The sulfoalkylated cellulose of the invention is a modified cellulose having superabsorbent properties. The sulfoalkylated cellulose of the invention is water swellable, water insoluble, has a high liquid absorption capacity, and is characterized by rapid uptake of water. Water swellability is imparted to the modified cellulose through sulfoalkylation. The sulfoalkylated cellulose has a degree of sulfonate group substitution sufficient to provide advantageous water swellability. The sulfoalkylated cellulose has a liquid absorption capacity that is increased compared to unmodified fluff pulp fibers.

As used herein, the term “sulfoalkylated cellulose” refers to cellulose that has been modified by alkylation with a sulfoalkylating agent to provide cellulose having pendant alkyl sulfonate groups. The sulfoalkylated cellulose of the invention is a cellulose ether in which cellulose hydroxy groups are etherified (i.e., alkylated) with alkyl sulfonate groups. The alkyl sulfonate groups are covalently coupled to cellulose through ether groups. As used herein, the term “sulfonate” refers to sulfonic acid and sulfonic acid salts, for example, sodium and potassium salts.

The sulfoalkylated cellulose of the invention can be obtained by alkylation (i.e., etherification) of cellulose (e.g., alkali cellulose) with suitable sulfoalkylating agents. Suitable sulfoalkylating agents include haloalkyl sulfonates and vinyl sulfonates (and their metal salts, e.g., sodium and potassium). Suitable haloalkyl sulfonates include chloroethyl sulfonate (CES), bromoethyl sulfonate (BES), and 3-chloro-2-hydroxypropyl sulfonate (CHPS). Chloroethyl sulfonate is commercially available from a variety of sources or can be prepared by the reaction of vinyl chloride and sodium bisulfite in alcohol solvent. 3-Chloro-2-hydroxypropyl sulfonate is also commercially available from a variety of sources or by reaction of epichlorohydrin with sodium bisulfite. Vinyl sulfonate (sodium form) is commercially available from a variety of sources.

Cellulosic fibers suitable for use in forming the sulfoalkylated cellulose of the invention are substantially water insoluble and not highly water swellable. After sulfoalkylation in accordance with the invention, the resulting sulfoalkylated cellulose is water swellable and water insoluble. As used herein, a material will be considered to be water soluble when it substantially dissolves in excess water to form a solution, losing its form and becoming essentially evenly dispersed throughout a water solution. As used herein, the terms “water swellable” and “water insoluble” refer to cellulose that, when exposed to an excess of an aqueous medium (e.g., bodily fluids such as urine or blood, water, synthetic urine, or 1 weight percent solution of sodium chloride in water), swells to an equilibrium volume, but does not dissolve into solution.

The sulfoalkylated cellulose of the invention can be characterized as having an average degree of sulfonate group substitution of from about 0.1 to about 2.0. In one embodiment, the cellulose has an average degree of substitution of from about 0.2 to about 1.0. In another embodiment, the cellulose has an average degree of substitution of from about 0.3 to about 0.5. As used herein, the “average degree of sulfonate group substitution” refers to the average number of moles of sulfonate groups per mole of glucose unit in the polymer. It will be appreciated that the sulfoalkylated cellulose formed in accordance with the invention will include a distribution of sulfonated cellulose having an average degree of substitution as noted above.

The sulfoalkylated cellulose of the invention has a liquid absorbent capacity of at least about 5 g/g as measured by the centrifuge capacity test described in Example 2. In one embodiment, the sulfoalkylated cellulose has a capacity of at least about 10 g/g. In another embodiment, the sulfoalkylated cellulose has a capacity of at least about 15 g/g. In a further embodiment, the sulfoalkylated cellulose has a capacity of at least about 20 g/g.

In another aspect of the invention, methods for making the sulfoalkylated cellulose are provided. In the method, alkali cellulose is sequentially treated with first and second sulfoalkylating agents. In one embodiment, the method includes the following steps:

(a) treating cellulose with alkali to provide alkali cellulose;

(b) treating the alkali cellulose with a first sulfoalkylating agent to provide a first sulfoalkylated cellulose;

(c) treating the first sulfoalkylated cellulose with a second sulfoalkylating agent to provide a second sulfoalkylated cellulose; and

(d) isolating the second sulfoalkylated cellulose to provide the product sulfoalkylated cellulose.

In another embodiment, the method includes the following steps:

(a) treating cellulose with an alkaline solution of vinyl sulfonate to provide a first sulfoalkylated cellulose;

(b) treating the first sulfoalkylated cellulose with a second sulfoalkylating agent to provide a second sulfoalkylated cellulose; and

(c) isolating the second sulfoalkylated cellulose to provide the product sulfoalkylated cellulose.

In one embodiment, the cellulose is treated with alkali in a suspension comprising isopropanol. In one embodiment, the alkali includes sodium hydroxide.

In one embodiment, the first sulfoalkylating agent is a haloethyl sulfonate, for example, chloroethyl sulfonate.

In one embodiment, the first sulfoalkylating agent is a vinyl sulfonate, for example, sodium vinyl sulfonate.

In one embodiment, the second sulfoalkylating agent is a 3-halo-2-hydroxypropyl sulfonate, for example, 3-chloro-2-hydroxypropyl sulfonate.

In one embodiment, the first sulfoalkylating agent is chloroethyl sulfonate and the second sulfoalkylating agent is 3-chloro-2-hydroxypropyl sulfonate.

In one embodiment, the first sulfoalkylating agent is vinyl sulfonate and the second sulfoalkylating agent is 3-chloro-2-hydroxypropyl sulfonate.

As noted above, the sulfoalkylated cellulose of the invention can be prepared by alkalizing cellulose to provide alkali cellulose, followed by etherifying the alkali cellulose with the first and second sulfoalkylating agents.

Alternatively, the sulfoalkylated cellulose of the invention can be prepared by alkalizing cellulose in the presence of vinyl sulfonate.

Alkali cellulose can be prepared in any one of a variety of ways. In a solvent-free method, fluff pulp (e.g., Retsch-milled fluff pulp) is wetted with a solution of aqueous sodium hydroxide (about 30-35% by weight sodium hydroxide) at low temperature (e.g., 0 to −5° C.). In the method, the molar ratio of pulp:sodium hydroxide:water is 1:1-4:14-17. Alternatively, alkali cellulose can be prepared by a suspension method in which pulp is suspended in a water-miscible organic solvent (e.g., isopropanol) to provide a suspension having a consistency of from about 3 to about 10%. To the suspension is added an aqueous sodium hydroxide solution (30-35% by weight sodium hydroxide), or an aqueous sodium hydroxide solution containing vinyl sulfonate, at low temperature (e.g., 0 to −5° C.) with vigorous stirring so as to evenly distribute the alkali throughout the fibers. The resulting mixture is then ripened at low temperature for at least two hours, with the entire process being carried out under a nitrogen atmosphere.

The sulfoalkylated cellulose is prepared by reacting alkali cellulose with first and second sulfoalkylating agents (e.g., haloalkyl sulfonates or vinyl sulfonates). The alkali cellulose is reacted with the sulfoalkylating agents at a temperature from about 50° C. to about 80° C. under a nitrogen atmosphere for 3-9 hours with constant stirring. The sulfoalkylating agents can be added as powders to a stirred suspension of the alkali cellulose in isopropanol.

In a representative method, haloalkyl sulfonates in powder form were added over a period of about 30 to 60 minutes to ripened alkali cellulose suspended in isopropanol under nitrogen while the temperature of the suspension was raised from ambient temperature to about 55° C. After the addition of the sulfoalkylating agents was complete, the mixture was heated at 55-60° C. for 3 to 9 hours. After cooling, the mixture was decanted or filtered, and the solids were washed sequentially with 75% aqueous isopropanol, acetic acid/isopropanol, and isopropanol, and dried.

In another representative embodiment, an aqueous solution of sodium hydroxide and sodium vinyl sulfonate were added over a 1 hour period to a pulp suspension in isopropanol. The mixture was kept at −5-0° C. for 90 minutes before slowly heating to 50-70° C. for 3-9 hours. A second sulfoalkylating agent (e.g., 3-chloro-2-hydroxypropyl sulfonate) was added and the mixture agitated with heating for 3-6 hours.

In one embodiment, the product sulfoalkylated cellulose was obtained by dissolving the reaction product in water (e.g., to provide a 2-5% by weight solution) and then precipitating the cellulose from the solution by the addition of a non-solvent (e.g., isopropanol or acetone).

In one embodiment, the sulfoalkylated cellulose is obtained by treating alkali cellulose with an amount of two sulfoalkylating agents sufficient to provide a water swellable, water insoluble product. This sulfoalkylated cellulose is obtained by sequential treatment with chloroethyl sulfonate or vinyl sulfonate followed by treatment with 3-chloro-2-hydroxypropyl sulfonate. It is believed that the product sulfoalkylated cellulose is a cellulose ether derivative that includes ethyl sulfonate and 2-hydroxypropyl sulfonate groups.

In a representative method for making the sulfoalkylated cellulose, about ⅙ to about ½ mole chloroethyl sulfonate or vinyl sulfonate per anhydroglucose unit (AGU) (162 g/mole) of cellulose is used in treating the alkali cellulose. The second sulfoalkylating agent, 3-chloro-2-hydroxypropyl sulfonate, is then added in an amount about twice that of the molar proportion of chloroethyl sulfonate added.

Water insolubility of the sulfoalkylated cellulose is believed to result from alkylation with 3-chloro-2-hydroxypropyl sulfonate (CHPS). CHPS is believed to react as a glycidyl sulfonate derivative (i.e., 2,3-epoxy-1-propyl sulfonate or oxirane methyl sulfonate) under alkaline conditions.

Reaction of alkali cellulose with chloroethyl sulfonate or vinyl sulfonate and 3-chloro-2-hydroxypropyl sulfonate provides a sulfoalkylated cellulose having a rapid water uptake, while remaining water insoluble.

The preparation of representative sulfoalkylated celluloses of the invention are described in Examples 1-3.

Cellulosic fibers are a starting material for preparing the sulfoalkylated cellulose of the invention. Although available from other sources, suitable cellulosic fibers are derived primarily from wood pulp. Suitable wood pulp fibers for use with the invention can be obtained from well-known chemical processes such as the kraft and sulfite processes, with or without subsequent bleaching. Pulp fibers can also be processed by thermomechanical, chemithermomechanical methods, or combinations thereof. Caustic extractive pulp such as TRUCELL, commercially available from Weyerhaeuser Company, is also a suitable wood pulp fiber. A preferred pulp fiber is produced by chemical methods. Ground wood fibers, recycled or secondary wood pulp fibers, and bleached and unbleached wood pulp fibers can be used. Softwoods and hardwoods can be used. Details of the selection of wood pulp fibers are well-known to those skilled in the art. These fibers are commercially available from a number of companies, including Weyerhaeuser Company, the assignee of the present invention. For example, suitable cellulosic fibers produced from southern pine that are usable with the present invention are available from Weyerhaeuser Company under the designations CF416, NF405, PL416, FR416, and NB416. In one embodiment, the cellulosic fiber useful in making the polymer of the invention is a southern pine fiber commercially available from Weyerhaeuser Company under the designation NB416. In other embodiments, the cellulosic fiber can be selected from among a northern softwood fiber, a eucalyptus fiber, a rye grass fiber, and a cotton fiber.

Cellulosic fibers having a wide range of degree of polymerization are suitable for forming the sulfoalkylated cellulose of the invention. In one embodiment, the cellulosic fiber has a relatively high degree of polymerization, greater than about 1000, and in another embodiment, about 1500.

In another aspect, the invention provides absorbent products that include the sulfoalkylated cellulose described above. The sulfoalkylated cellulose can be incorporated into a personal care absorbent product. The sulfoalkylated cellulose can be formed into a composite for incorporation into a personal care absorbent product. Composites can be formed from the sulfoalkylated cellulose alone or by combining the sulfoalkylated cellulose with other materials, including fibrous materials, binder materials, other absorbent materials, and other materials commonly employed in personal care absorbent products. Suitable fibrous materials include synthetic fibers, such as polyester, polypropylene, and bicomponent binding fibers; and cellulosic fibers, such as fluff pulp fibers, crosslinked cellulosic fibers, cotton fibers, and CTMP fibers. Suitable absorbent materials include natural absorbents, such as sphagnum moss, and synthetic superabsorbents, such as polyacrylates (e.g., SAPs).

Absorbent composites derived from or that include the sulfoalkylated cellulose of the invention can be advantageously incorporated into a variety of absorbent articles such as diapers including disposable diapers and training pants; feminine care products including sanitary napkins, and pant liners; adult incontinence products; toweling; surgical and dental sponges; bandages; food tray pads; and the like. Thus, in another aspect, the present invention provides absorbent composites, constructs, and absorbent articles that include the sulfoalkylated cellulose.

The sulfoalkylated cellulose can be incorporated as an absorbent core or storage layer into a personal care absorbent product such as a diaper. The composite can be used alone or combined with one or more other layers, such as acquisition and/or distribution layers, to provide useful absorbent constructs.

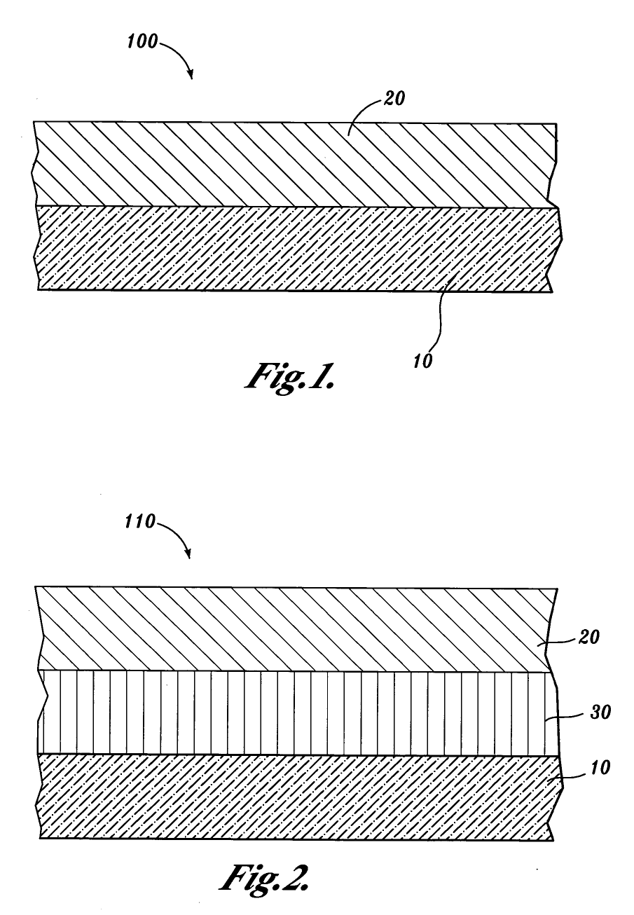

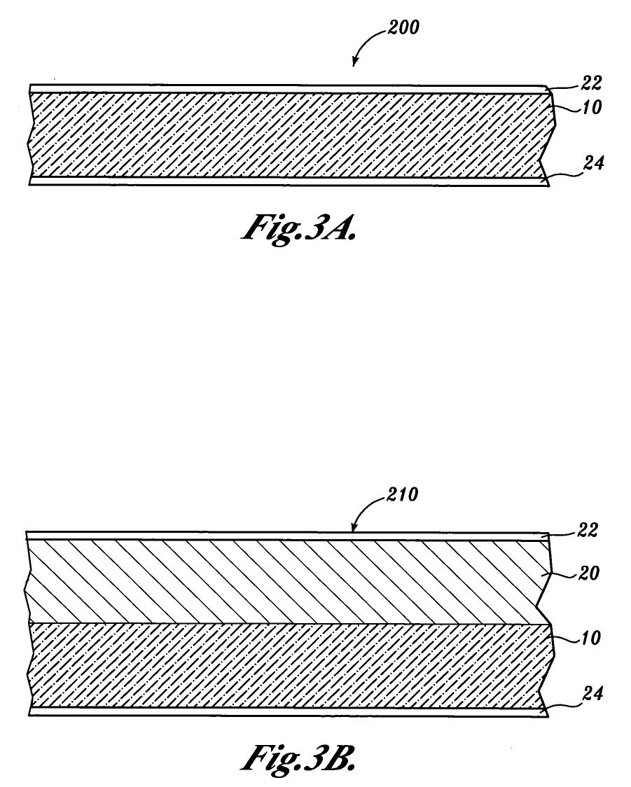

Representative absorbent constructs incorporating an absorbent composite that includes the sulfoalkylated cellulose of the invention are shown in FIGS. 1 and 2. Referring to FIG. 1, construct 100 includes composite 10 (i.e., a composite that includes a sulfoalkylated cellulose) employed as a storage layer in combination with an upper acquisition layer 20.

In addition to the construct noted above that includes the combination of absorbent composite and acquisition layer, further constructs can include a distribution layer intermediate the acquisition layer and composite. FIG. 2 illustrates construct 110 having intermediate layer 30 (e.g., distribution layer) interposed between acquisition layer 20 and composite 10.

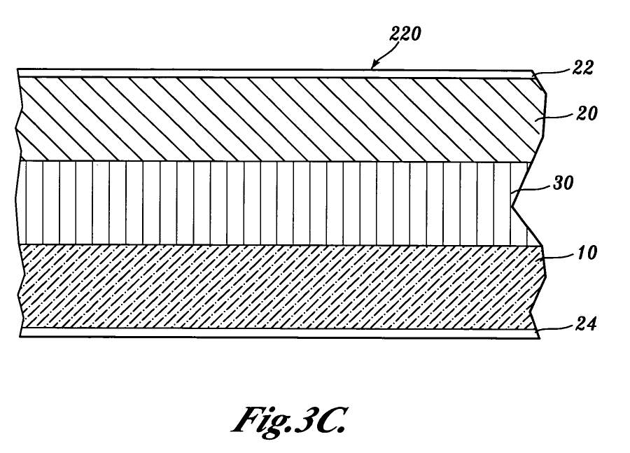

Composite 10 and constructs 100 and 110 can be incorporated into absorbent articles. Generally, absorbent articles 200, 210, and 220 shown in FIGS. 3A-C, include liquid pervious facing sheet 22, liquid impervious backing sheet 24, and a composite 10, construct 100, construct 110, respectively. In such absorbent articles, the facing sheet can be joined to the backing sheet.

It will be appreciated that other absorbent products can be designed incorporating the sulfoalkylated cellulose and composites that include the cellulose.

The following examples are provided for the purpose of illustrating, not limiting, the present invention.

### EXAMPLES

### Example 1

### The Preparation of a Representative Sulfoalkylated Cellulose

In this example, a method for forming a representative sulfoalkylated cellulose is described. In the method, cellulose was alkalized and then sequentially treated with chloroethyl sulfonate and 3-chloro-2-hydroxypropyl sulfonate.

Alkalized fluff pulp was prepared mixing 10.6 g (65.4 mM) fluff pulp (NB416, Weyerhaeuser company, Federal Way, Wash.) in 200 mL isopropanol in 500 mL Erlenmeyer flask with 23 mL 35 weight percent aqueous sodium hydroxide (8 g, 200 mM). The mixture was stored overnight at −5° C. The alkali cellulose was suspended in 200 mL isopropanol and stirred under nitrogen in a reactor kettle situated in a water bath. The temperature was raised to 55° C. and then 3.42 g (20.4 mM) 2-chloroethanesulfonic acid, sodium salt, was added. After 3 hours at 55° C., 8.1 g (41.4 mM) 3-chloro-2-hydroxypropanesulfonic acid, sodium salt, was added. The molar ratio of sulfoalkylating agents to anhydroglucose units was 1:1. The reaction mixture was stirred for 2 hours at 55° C. and then allowed to stand overnight at room temperature under nitrogen (about 14 hours). The reaction mixture was then heated to 55° C. and stirred for 4 hours. After cooling to room temperature, the reaction mixture was neutralized with acetic acid and the product collected by filtration. The collected product was washed with 70 percent aqueous isopropanol (2×), 90 percent aqueous isopropanol, and absolute isopropanol, and then air dried.

The product had a Free Swell Capacity of about 34.47 g/g and a Centrifuge Capacity of about 8.85 g/g.

### Example 2

### The Preparation of a Representative Sulfoalkylated Cellulose

In this example, a method for forming a representative sulfoalkylated cellulose is described. In the method, cellulose was alkalized and then sequentially treated with vinyl sulfonate and 3-chloro-2-hydroxypropyl sulfonate.

Alkalized fluff pulp was prepared by mixing fluff pulp (NB416, Weyerhaeuser company, Federal Way, Wash.) in isopropanol in a flask with an aqueous sodium hydroxide solution. The alkaline solution was added dropwise over a 30 minute period. The mixture was stirred mechanically at a temperature of −5-0° C. for 90 minutes under nitrogen. After alkalization was complete (about 2 hours), vinyl sulfonate sodium salt was added and the mixture was slowly heated to 60° C. Stirring was continued for 3 hours before 3-chloro-2-hydroxypropanesulfonic acid, sodium salt, was added. The molar ratio of sulfoalkylating agents to anhydroglucose units was 1:1. The reaction was kept stirring at 50° C. overnight (about 14 hours) under nitrogen. The reaction mixture was neutralized with acetic acid and the product collected by filtration. The collected product was washed with 70 percent aqueous isopropanol (2×), 90 percent aqueous isopropanol, and absolute isopropanol, and then air dried.

### Example 3

### The Preparation of a Representative Sulfoalkylated Cellulose

In this example, a method for forming a representative sulfoalkylated cellulose is described. In the method, cellulose was alkalized in the presence of vinyl sulfonate and then treated with 3-chloro-2-hydroxypropyl sulfonate.

Alkalized fluff pulp was prepared by adding a solution of aqueous sodium hydroxide in 25 percent by weight aqueous vinyl sulfonate to a suspension of fluff pulp (NB416, Weyerhaeuser company, Federal Way, Wash.) in isopropanol in an ice bath. The alkaline solution was added dropwise over a 30 minute period under nitrogen. The mixture was then treated with 3-chloro-2-hydroxypropanesulfonic acid, sodium salt, as described in Example 2.

### Example 4

### Method for Determining Free Swell Capacity and Centrifuge Capacity

In this example, a method for determining free swell capacity (g/g) and centrifuge capacity (g/g) is described.

The materials, procedure, and calculations to determine free swell capacity (g/g) and centrifuge capacity (g/g) were as follows.

Test Materials:

Japanese pre-made empty tea bags (available from Drugstore.com, IN PURSUIT OF TEA polyester tea bags 93 mm×70 mm with fold-over flap. (http:www.mesh.ne.jp/tokiwa/).

Balance (4 decimal place accuracy, 0.0001 g for air-dried superabsorbent polymer (AD SAP) and tea bag weights).

Timer.

1% Saline.

Drip rack with clips (NLM 211)

Lab centrifuge (NLM 211, Spin-X spin extractor, model 776S, 3,300 RPM, 120 v).

Test Procedure:

1. Determine solids content of AD SAP.

2. Pre-weigh tea bags to nearest 0.0001 g and record.

3. Accurately weigh 0.2025 g+/−0.0025 g of test material (SAP), record and place into pre-weighed tea bag (air-dried (AD) bag weight). (AD SAP weight+AD bag weight=total dry weight).

4. Fold tea bag edge over closing bag.

5. Fill a container (at least 3 inches deep) with at least 2 inches with 1% saline.

6. Hold tea bag (with test sample) flat and shake to distribute test material evenly through bag.

7. Lay tea bag onto surface of saline and start timer.

8. Soak bags for specified time (e.g., 30 minutes).

9. Remove tea bags carefully, being careful not to spill any contents from bags, hang from a clip on drip rack for 3 minutes.

10. Carefully remove each bag, weigh, and record (drip weight).

11. Place tea bags onto centrifuge walls, being careful not to let them touch and careful to balance evenly around wall.

12. Lock down lid and start timer. Spin for 75 seconds.

13. Unlock lid and remove bags. Weigh each bag and record weight (centrifuge weight).

Calculations:

The tea bag material has an absorbency determined as follows:

Free Swell Capacity, factor=5.78

Centrifuge Capacity, factor=0.50

Free Capacity (g/g):

$$\frac{\begin{matrix}[ drip wt ( g ) - dry bag wt ( g ) - \\ ( AD SAP wt ( g ) ] - [ dry bag wt ( g ) * 5.78 ]\end{matrix}}{[ AD SAP wt ( g ) * Z ]}$$

Centrifuge Capacity (g/g):

$$\frac{\begin{matrix}[ centrifuge wt ( g ) - dry bag wt ( g ) - \\ ( AD SAP wt ( g ) ] - [ dry bag wt ( g ) * 0.50 ]\end{matrix}}{[ AD SAP wt ( g ) * Z ]}$$

Z=Oven dry SAP (g)/Air dry SAP (g)

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. Sulfoalkylated cellulose, comprising cellulose substituted with ethyl sulfonate groups and 2-hydroxypropyl sulfonate groups.

2. The cellulose of claim 1, wherein the ethyl sulfonate groups are covalently coupled to cellulose through ether groups.

3. The cellulose of claim 1, wherein the 2-hydroxypropyl sulfonate groups are covalently coupled to cellulose through ether groups.

4. Sulfoalkylated cellulose, comprising cellulose treated with (a) a haloethyl sulfonate or vinyl sulfonate and (b) a 3-halo-2-hydroxypropyl sulfonate.

5. The cellulose of claim 4, wherein the haloethyl sulfonate is bromoethyl sulfonate.

6. The cellulose of claim 4, wherein the haloethyl sulfonate is chloroethyl sulfonate.

7. The cellulose of claim 4, wherein the vinyl sulfonate is vinyl sulfonate, sodium salt.

8. The cellulose of claim 4, wherein the 3-halo-2-hydroxypropyl sulfonate is 3-chloro-2-hydroxypropyl sulfonate.

9. The cellulose of claim 4, wherein the haloethyl sulfonate is chloroethyl sulfonate and the 2-halo-3-hydroxypropyl sulfonate is 3-chloro-2-hydroxypropyl sulfonate.

10. A method for making sulfoalkylated cellulose, comprising,
(a) treating cellulose with alkali to provide alkali cellulose;
(b) treating the alkali cellulose with a first sulfoalkylating agent to provide a first sulfoalkylated cellulose;
(c) treating the first sulfoalkylated cellulose with a second sulfoalkylating agent to provide a second sulfoalkylated cellulose; and
(d) isolating the second sulfoalkylated cellulose to provide sulfoalkylated cellulose.

11. The method of claim 10, wherein the cellulose is treated with alkali in a suspension comprising isopropanol.

12. The method of claim 10, wherein the alkali comprises sodium hydroxide.

13. The method of claim 10, wherein the first sulfoalkylating agent is a haloethyl sulfonate.

14. The method of claim 10, wherein the first sulfoalkylating agent is chloroethyl sulfonate.

15. The method of claim 10, wherein the first sulfoalkylating agent is vinyl sulfonate.

16. The method of claim 10, wherein the second sulfoalkylating agent is 3-chloro-2-hydroxypropyl sulfonate.

17. The method of claim 10, wherein the first sulfoalkylating agent is chloroethyl sulfonate and the second sulfoalkylating agent is 3-chloro-2-hydroxypropyl sulfonate.

18. The method of claim 10, wherein the first sulfoalkylating agent is vinyl sulfonate and the second sulfoalkylating agent is 3-chloro-2-hydroxypropyl sulfonate.
